(19) United States
(12) Patent Application Publication
(10) Pub. No.: US 2011/0199210 A1
(43) Pub. Date: Aug. 18, 2011

(54) OR RELATING TO SECURITY DEVICES

(76) Inventor: Isla Ann McLean, Edinburgh (GB)

(21) Appl. No.: 12/672,382

(22) PCT Filed: Aug. 6, 2008
(86) PCT No.: PCT/EP08/06461

§ 371 Date: Feb. 5, 2010

(30) Foreign Application Priority Data
Aug. 6, 2007 (GB) 0715262.2

(51) Int. Cl. G08B 13/14

(52) U.S. Cl. 340/568.1

(57) ABSTRACT

A security device for items is provided comprising a locking cable which is connected to a device worn by the owner which activates an alarm if broken or damaged while in the locking environment, the device and the item are bridged by the cable and the device may be worn by the user or integrated with the item to be secured.

The present invention relates to personal security devices which may be used to secure possessions and which will provide an alarm if unauthorised attempts are made to remove the possession.

The invention provides an activatable alarm system which may be attached to an individual and connected to a cord or cable for bridging the individual and the means to be secured wherein any break or tampering in the cord or cable activates the alarm system. In one embodiment the cable may activate an alarm if the cable is detached from the security device and not when the actual cable is broken. In such circumstance, the cable can be made of a strong material for example wire such as steel wire coated with a nylon cover or such like, thus making it difficult to break without extreme force.

The system of the present invention may be used to secure personal possessions whilst in public places. The security may be achieved by attaching the possession to an individual and provides a device that will alert the owner to any attempt to remove the possessions that have been secured.

In a further embodiment the system of the present invention can be used as a time alarm to alert the owner at a pre-set time on the device set by the owner for personal reason, for example before they reach their connecting transport or final destination.

In a preferred embodiment the alarm system of the device comprises a secure flexible strap preferably made of a strong and easy to wear material such as that used to make car seat belts. The strap is flexible so as to fit around a body part and is provided with attachment means to secure it around the body part such as the wrist or ankle. For example, the strap may be provided with Velcro designed to fit around a body part, the strap may also include a clip or padlock attachment to provide additional security; in this instance the strap may be provided with eyelets that penetrate the strap sufficiently for the padlock to be secured through them. The choice of material for the strap depends upon its use and it may also be a combination of many layers of straps interlocking. A double strap with open and close method in opposing directions is particularly useful. The strap may be patterned with a multitude of inter-woven coloured fabrics or be a single colour. Providing the strap materials are strong enough to resist breaking, tearing or being removed by a third party in a quick violent motion any appropriate material can be selected including plastics and rubbers. The system should however be released and activated when a force is applied that could injure the wearer. In particular we prefer that the cord or cable will be released under a force 0.5 and 10 kilogram, particularly between 5 and 10 kilograms, particularly 6 to 8 kilograms although in some embodiments a force of 0.5 to 2.5 kilograms may be preferred.

The strap can be used to carry the various other components of the device of the invention. The following components may be attached to the strap in a manner similar to that in which a watch can be attached to a strap for wearing on a human wrist. A timer, can be attached and the timer may include a digital watch which can be set by the owner to sound an alarm at a chosen time. Alternatively the timer can be a dial or a switch which will sound an alarm after a given period of time for example 1, 3, 6 or 8 hours. In this embodiment a digital display may not be required. The alarm can provide an audio alarm, a vibrating alarm and/or a visual alarm.

The security cord of the security device of the present invention is preferably an electrical conductor so that the alarm is activated when the electrical circuit is broken. In this embodiment the device of the present invention contains electronic circuitry to integrate the security cord or cable with the alarm device and the circuitry may be part of the strap. The alarm is provided with means to set the alarm such as on/off buttons and these are preferably provided on the underside of the device (the side in contact with the user) to prevent accidental activation or deactivation. The means may be countersunk in the underside of the device. Alternatively, a reset button could be used which would only reset the alarm when it has already been activated, but would not be able to turn the device off when in use. A further feature being that the alarm will turn itself off after a set period of time for example one or two minutes.

Whilst a wind up/clockwork solar powered or kinetic method of generating power may be used we prefer to use a small replaceable battery such as a watch battery as the power source. The power source drives the circuit that operates the timer, an alarm with means for sounding an alarm and a circuit breaker which when broken triggers the alarm independently of the timer. One or more on/off light emitting displays may be used to identify settings but we prefer to use a display as the interface between the user and the electronics. The light emitting elements can be luminous to enable them to be observed in dark conditions. In a preferred embodiment the cord or cable is housed within a single casing as an extendable cable. We also prefer to provide a means for turning the power on and off but which cannot be turned off when the timer has been activated. Preferably this is provided in the base of the housing. We also prefer that these means are provided on the underside of the housing so that they bear against the wearers skin making it difficult for a third party to inactivate the system. Alternatively this may be accomplished if the strap may pass between the device and the user so that the underside of the housing bears against the strap rather than the skin of the user. In a preferred embodiment these means are countersunk in the underside of the housing. In addition means to manually set the timer may be provided. A visual aid may also be provided to alert the user when the power supply is running low.

It is preferred that when the security cord or cable is integrated with the strap it is a manually retractable and extendable electric cord/cable. This cord is of conducting material and is preferably connected to the electric circuit and will trigger the alarm if the cord is cut or detached from the circuit. The cord comprises a conductive material connected to the electronic circuit and runs through the cable's core which is formed in a loop which re-joins the circuit. A flexible plastic or rubber coating can surround the conductive material providing sufficient insulation so that current is not transferred to the outside of the housing. To act as a strengthener or barrier, a protective sleeve may be used comprising Kevlar or the like to add additional strength and resistance. The cable is connected to the circuit and is preferably looped at the exposed end. In a preferred embodiment the cable leaves the embodiment (not cable), loops back on itself after a certain distance such as two metres and re-enters the embodiment (in cable). Where the cable loops back on itself, the out cable and in cable are fixed together forming a loop at the end. This loop can be large enough for the whole embodiment to fit through it. Therefore if any part of the cable is cut, including the loop, an alarm will sound. The loop has the additional benefit of acting as a handle for the user and as the security mechanism for connecting the device to hand luggage or personal belongings and can be attached around the users wrist, ankle or waist. Prior to wearing the strap of the invention, the cord can be threaded through the handle(s) of the luggage and the strap then fed through the loop of the cord providing a secure attachment between luggage and invention. The strap can then be worn so that the user is connected to their luggage. The strap can be provided with an attachment device for securing the loop in the security cord when it is not in use.

Whilst it is possible to have an automated cable cord or cable mechanism which can automatically retract the cord, we prefer to use a manually adjustable cable since it provides simplicity in design offering greater strength and security at critical moments. The cord or cable can be housed in a case which may or may not surround the timer. The cord is preferably able to be manually wound in or out by the user. Furthermore, the cord will preferably be able to be locked off at a desired length using a ratchet mechanism, screw thread or similar. In a preferred embodiment the cord can be retained by means of a rubber seal provided around the cable exit hole to prevent the cable releasing too early and/or falling out of the housing without an applied force. This prevents the cord from creating a consistent pulling force which if worn during long travel periods will create discomfort for the user. This is made possible by the design of the housing surrounding the cable, it may be a single unit or two or more parts joined. One part will be free to rotate in both directions allowing the cord to be wound in and out. The same part is preferably shaped to allow fingers or thumbs to interact with the component providing the twist or rotations. Additionally, when the cord is extended, the housing allows the user to hold the cord and pull it to obtain the desired length. We also prefer that the housing is provided with a removable cover so that it can be removed in the event that the cord becomes tangled. The housing may be transparent and may be provided with any desirable aesthetic appearance.

The invention has been described in relation to an embodiment in which the cord or cable is permanently attached to the strap to be worn by the individual and is extended to attach to the article to be protected. In an alternative embodiment the cord or cable can be provided on the article which is to be protected and it can be extended from the article and connected to the activatable alarm system worn by the user. As a further embodiment both the activatable alarm system and the cord may be integral with the article to be protected and the cord provided with means whereby it may be attached to the user for example to the users ankle, waist or wrist. In this embodiment the article to be protected may be provided with a pocket or compartment for storing the system or the system may be fabricated to be integral with the article. The cable may exit and re-enter the embodiment at separate points. Where this is the case, the cable can exit the embodiment, thread through the users luggage and then re-enter the embodiment at a separate point.

In additional embodiments a light can be included in the device to help use in the dark, for example a LED may be included.

The invention may be used to protect a wide variety of articles including handbags, wallets, purses and luggage of various, sorts. The invention is particularly useful for travellers and holiday makers where they can secure the articles during journeys where they are vulnerable to theft of the articles. For example when falling asleep in a train, bus or aircraft.

It is important that the cord or cable is such that it can be broken and activate the alarm when subjected to a force less than that required to injure the individual. We therefore prefer that the cord or cable is such that it can be broken and/or released when subject to a force of between 0.5 and 10 kilograms preferably 5 and 10 kilograms although in some instances we prefer that the alarm be activated by a force of 0.5 to 2.5 kilograms.

The invention is illustrated by references to the accompanying drawings in which

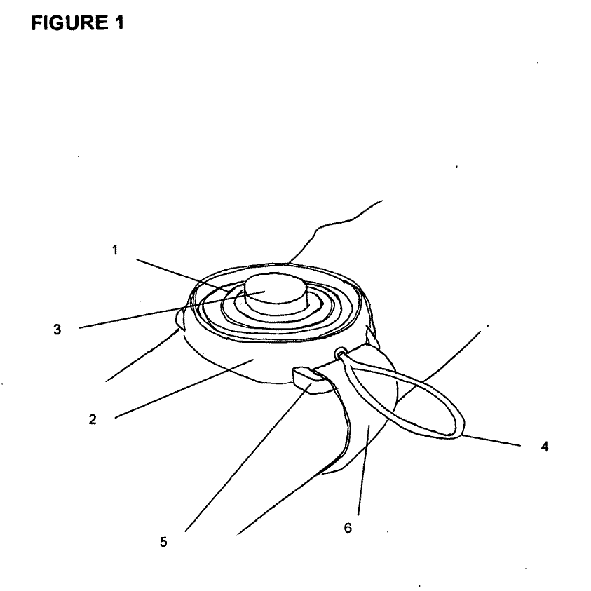

FIG. 1 shows an embodiment of the invention attached to the users wrist.

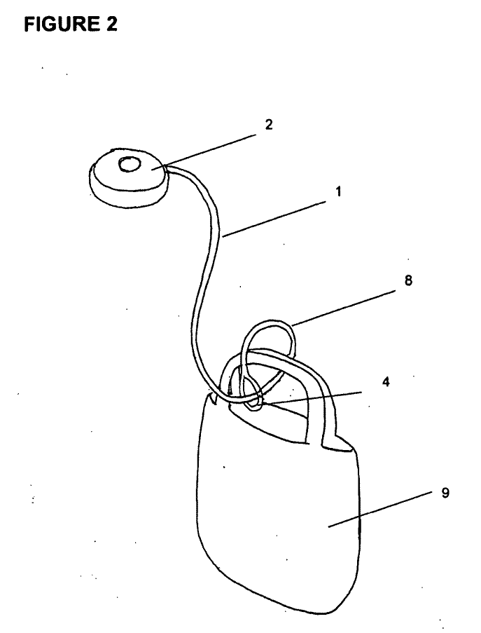

FIG. 2 is a diagrammatical illustration of the device of the invention attached to a handbag.

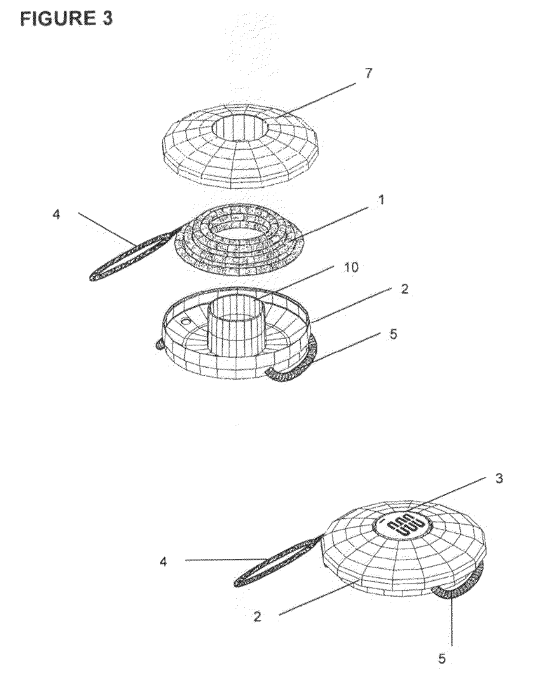

FIG. 3 shows how the cord or cable may be provided within the housing to provide the device shown in FIG. 1.

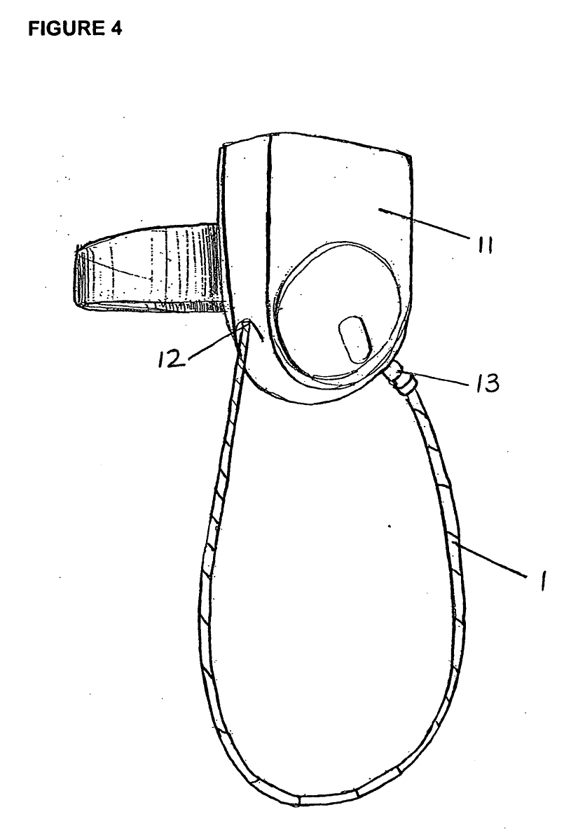

FIG. 4 shows an embodiment in which the cable or cord exits and re-enters the body of the device at separate points.

FIG. 1 shows an alarm system comprising a cable or cord (1) contained within a transparent housing (2) that is provided with a display (3). The cord is provided with a loop (4) that projects from the housing. The housing is also provided with means (5) for receipt of a strap (6) to allow the system to be attached to the users wrist. The cover (7) for the housing is removable to allow access to the cable (1).

FIG. 2 shows how the cord (1) may be extended from the housing and the loop used to attach the device to the handles (8) of a piece of luggage (9).

FIG. 3 illustrates how the cord or cable (1) may be wound around a central pillar (10) within the housing and how the cover (7) of the housing (2) can be removed.

FIG. 4 shows an embodiment in which the cable exits and re-enters the body of the device at separate points.

With the embodiment shown in FIG. 3 the circuitry (not shown) attached to the cord or cable and the power source can be provided within the pillar (10). The on/off switch for the system can be provided at the base of the housing (2).

FIG. 4 shows how the cord or cable (1) can exit the housing (11) at one point (12) and can re-enter at a separate point (13). In this instance the cord can be threaded through luggage (not shown) and clipped into the housing.

1. An activatable alarm system which may include a device to be attached to an individual and connected to a cord or cable for bridging the individual and an item to be secured wherein any break or tampering in the cord or cable activates the alarm system.

2. An activatable alarm system according to claim 1 in which the alarm is activated if the cord or cable is detached from the device.

3. An activatable alarm system according to claim 1 which can be used as a time alarm to alert an owner at a pre-set time set by the owner.

4. An activatable alarm system of claim 1 comprising a secure flexible strap to fit around a body part and provided with attachment means to secure it around the body part.

5. An activatable alarm system according to claim 4 in which the strap carries various components of the alarm system.

6. An activatable alarm system according to claim 4 in which the strap carries a timer.

7. An activatable alarm system according to claim 1 in which the alarm is an audio alarm, a vibrating alarm, a visual alarm, or any combination thereof.

8. An activatable alarm system according to claim 6 in which the device contains electronic circuitry to ingrate the security cord or cable with the alarm device and the circuitry is carried by the strap.

9. A system according to claim 8 in which a power source drives the circuit that operates the timer, and contains a circuit breaker which when broken triggers the alarm independently of the timer.

10. A system according to claim 4 in which the cable or cord is housed within a casing.

11. A system according to claim 10 in which the casing is mounted on the strap.

12. A system according to claim 10 in which the casing is provided with a removable cover.

13. A system according to claim 6 containing a means for turning the power on and off which cannot be turned off when the timer has been activated.

14. A system according to claim 1 in which the cord or cable exits and re-enters the device at separate points.

15. A system according to claim 13 in which the means for turning the power on and off is provided on the underside of the casing.

16. A system according to claim 4 in which the security cord or cable is integrated with the strap and is manually retractable.

17. A system according to claim 1 in which the alarm system is worn by a user and the cord or cable is attached to the item to be secured.

18. A system according to any of claim 1 in which the alarm system is worn by a user and the cord or cable is housed in the item to be secured.

19. A system according to claim 1 in which the alarm system and the cord or cable are housed in the item to be secured and the cord or cable is adapted for attachment to a user.

20. (canceled)
